(19) United States
(12) Patent Application Publication
(10) Pub. No.: US 2017/0337551 A1
(43) Pub. Date: Nov. 23, 2017

(54) Certification Pattern Determination Method and Payment Method Using Same

(71) Applicant: Hyunseok LEE, Seoul (KR)

(72) Inventor: Hyunseok LEE, Seoul (KR)

(21) Appl. No.: 15/522,020

(22) PCT Filed: Oct. 30, 2015
(86) PCT No.: PCT/KR2015/011575

§ 371 Date: Apr. 26, 2017

(30) Foreign Application Priority Data
Nov. 13, 2014 (KR) 10-2014-0157504

(51) Int. Cl. G06Q 20/38; G06F 3/0488; H04L 9/08; H04L 9/32

(52) U.S. Cl. CPC G06Q 20/385; H04L 9/3228; G06F 3/04886; H04L 9/0861; H04L 2209/56

(57) ABSTRACT

A certification pattern storage method according to the present invention comprises: (1) a first step of receiving, by a user terminal, an image including a random number table which is encoded into a one-time key generated on the basis of first information and sent by a server; (2) a second step of generating, by the user terminal, the one-time key on the basis of the first information and decoding the encoded image; (3) a third step of receiving, by the user terminal, characters arranged according to a predetermined pattern in the random number table; and (4) a fourth step of sending, by the user terminal, the pattern determined by means of the inputted characters to the server, and storing the pattern in the server.

### BACKGROUND OF THE INVENTION

### Field of the Invention

The present invention relates to a certification pattern determination method and a payment method using the same.

### Description of Related Art

Since purchasing and making payment for products or services online, for example, through an Internet shopping mall, and the like, is actually not facing payment but achieved online, a process of certifying whether the payment is normal payment is required.

As an example of the certification, publicized is a method through input of an SMS authentication number disclosed in Korean Patent Unexamined Publication No. 10-2009-0091051 published on Aug. 26, 2009. When a service such as Nate On is used, a cell phone text message may be viewed in a personal computer (PC) and when the PC is hacked, there is a possibility of payment by a malicious third person by snatching the SMS authentication number, and as a result, there is a security vulnerability.

### SUMMARY OF THE INVENTION

An object of the present invention is to provide a more step forward online payment certification method.

A certification pattern storage method according to the present invention includes: (1) a first step of encoding, by the server, an image including a random number table with a one-time key generated on the basis of first information and transmitting the encoded image and receiving, by the user terminal, the transmitted encoded image; (2) a second step of generating, by the user terminal, the one-time key on the basis of the first information and decoding the encoded image; (3) a third step of receiving, by the user terminal, characters arranged according to a predetermined pattern in the random number table; and (4) a fourth step of sending, by the user terminal, the pattern determined by means of the inputted characters to the server, and storing the pattern in the server.

A payment means information storage method according to the present invention includes: (5) a fifth step of receiving, by a user terminal, payment means information and transmitting the received payment means information to the server; (6) a sixth step of encoding, by the server, an image including a random number table and the payment means information with a one-time key generated on the basis of first information and transmitting the encoded image and receiving, by the user terminal, the transmitted encoded image when the payment means information is available; (7) a seventh step of decoding, by the user terminal, the encoded image with the one-time key on the basis of the first information; (8) an eighth step of receiving, by the user terminal, characters of the random number table and sending the received characters to the server; and (9) a ninth step of determining, by the server, whether the characters input in the eighth step coincide with the characters which follow a pattern stored in the fourth step and storing the payment means information when the characters coincide with each other and receiving, by the user terminal, a storage result.

A payment method according to the present invention includes: (10) a tenth step of encoding, by receiving, by a server receiving payment history information from an online shopping mall accessed by a user, an image including a random number table and payment history information with a one-time key generated on the basis of first information and transmitting the encoded image and receiving, by the user terminal, the transmitted encoded image; (11) an eleventh step of decoding, by the user terminal, the encoded image with the one-time key generated on the basis of the first information; (12) a twelfth step of receiving, by the user terminal, characters of the random number table and transmitting the received characters to the server; and (13) a thirteen step of determining, by the server, whether the characters input in the twelfth step coincide with the characters which follow a pattern stored in the fourth step and approving payment and receiving, by the user terminal, an approval result.

The user terminal may produce an image keyboard capable of inputting the characters displayed in the random number table.

According to the present invention, a user can make certification by inputting a text of a random number table which follows a predetermined certification pattern, and as a result, security increases as compared with a case of making certification by inputting a certification number received through a short message service (SMS).

### BRIEF DESCRIPTION OF THE DRAWINGS

FIG. 1 is a diagram illustrating a server, a user terminal, and an internal operation in which the present invention is performed.

FIG. 2 is a flowchart of a certification pattern storage method according to the present invention.

FIG. 3 is a diagram illustrating an example of an image displayed for setting a certification pattern.

FIG. 4 is a flowchart of a payment means setting method according to the present invention.

FIG. 5 is a diagram illustrating an example of an image displayed for setting payment means information.

FIG. 6 is a flowchart of a payment method according to the present invention.

FIG. 7 is a diagram illustrating an example of an image displayed for payment.

### DETAILED DESCRIPTION OF THE PREFERRED EMBODIMENTS

Hereinafter, preferable embodiments of the present invention will be described with reference to the accompanying drawings. In the description given below, it should be interpreted that a description order of a flowchart is not limitative except for a case where a preceding step needs to become a logic and inevitable preceding step of a succeeding step. That is, it should not be interpreted that it is excluded that the succeeding step is performed earlier than the preceding step.

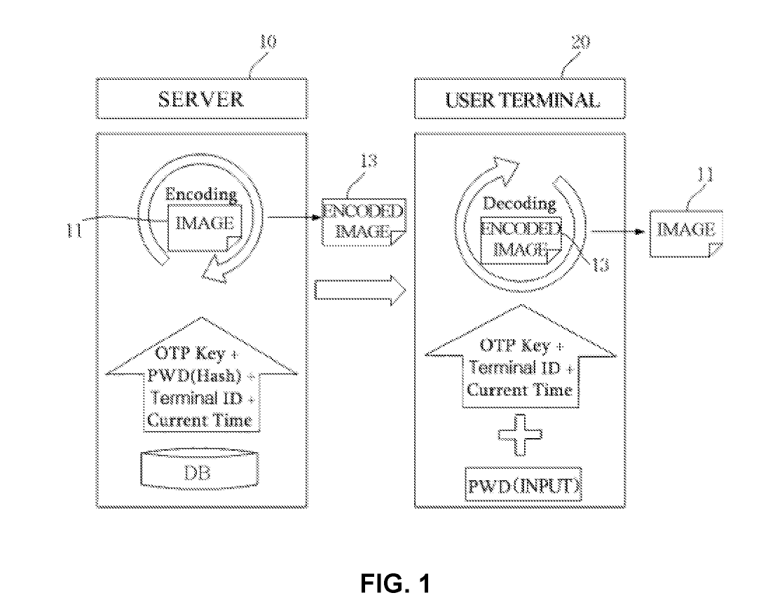

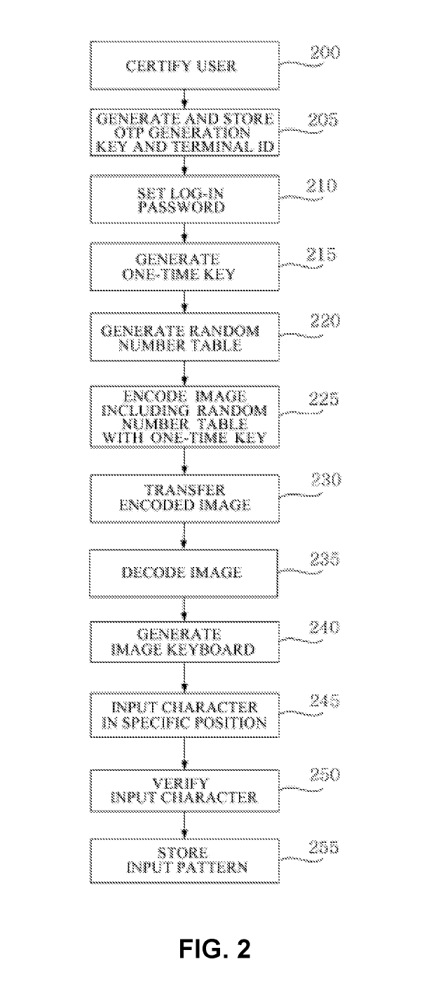

In FIG. 1, a server 10, a user terminal 20, and internal operations thereof in an environment in which the present invention is performed are illustrated. Contents included in an image 11 of FIG. 1 may vary depending on the operation. A certification pattern storage method according to the present invention is described with reference to FIG. 2.

Prior to carrying out the present invention, a user installs application software capable of storing and making payment for a certification pattern according to the present invention in the user terminal 20. In addition, membership joining that enables using a service according to the present invention is performed through a user certification process 200, and the like, (a log-in ID and a password are set), a terminal ID and a time based disposable password generation key (time OTP key; an electronic key to generate a disposable password based on a time) are generated, and the generated time based disposable password generation key is stored in the user terminal 20 and the server 10 (205 and 210). The terminal ID means information enabling distinguishment from other terminals, which includes a phone number of the user terminal, a terminal serial number, and the like, and there is no limit in the type thereof.

A method for storing the certification pattern which the user will use in a payment method according to the present invention is described. The certification pattern storage method may be consecutively performed in the membership joining and the time based disposable password setting and performed at a temporal interval.

In a certification pattern setting step, first, the server 10 generates a disposable key based on the time based disposable password generation key, time information (reflecting a predetermined time interval at which the time based disposable password is available) and the password corresponding to the relevant user terminal (215). As the password, a hash value of the password is preferable used rather than using an actual password.

In the present specification, information which is the basis of the one-time key is defined as “first information” and the first information may adopt all information which may include security. In the present specification, as one example of the first information, the time based one-time password generation key, the time information, and the password are used, but it should not be interpreted that the first information is not limited thereto and an average technician may select the first information and may use any information of which the security is guaranteed.

The server 10 generates a random number table (220) and the random number table may be extracted and generated from a random number generation parent set by using the terminal ID as a challenge value. As the challenge value, the user or information unique to the user may be used and it should not be interpreted that the channel value is limited to the terminal ID.

Next, the server 10 encodes the image 11 including the random number table generated in step 220 with the one-time key generated in step 215 (225) and transfers an encoded image 13 to the user terminal 20 (230).

The user terminal 20 decodes the encoded image with the one-time key generated based on the first information (235). The user terminal 20 generates an image keyboard by using the terminal ID as the change value (240). The generated image keyboard includes random numbers extracted by using the terminal ID as the challenge value and additionally includes other characters (including figures) to allow the user to input the characters of the random number table.

The challenge value used for generating the image keyboard needs to be the same as the challenge value used in step 220. The generation of the image keyboard is not a required component of the present invention and may be selectively applied.

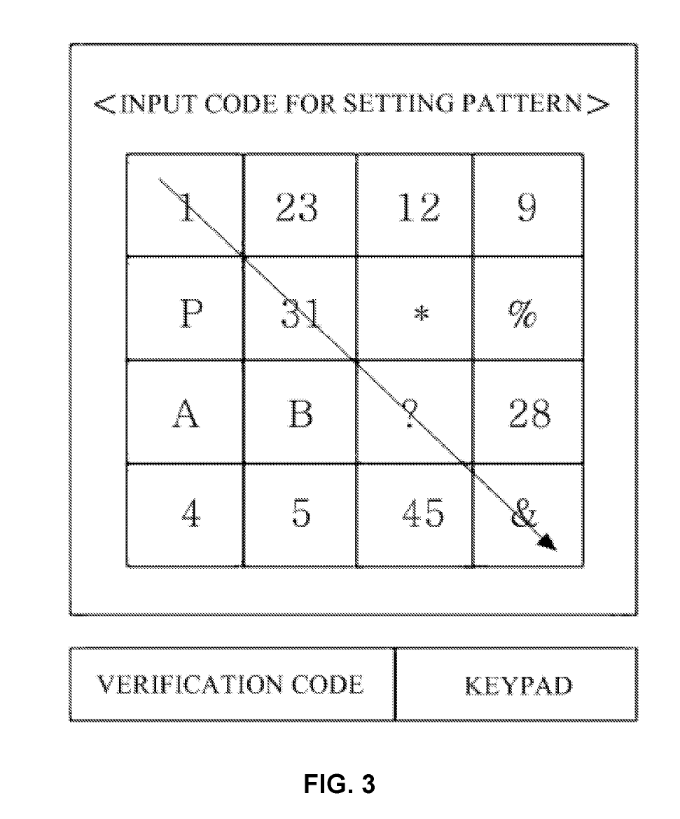

When the image is normally decoded in step 235, the random number table illustrated in FIG. 3 is displayed. Herein, the user inputs the characters which match a pattern order to be used as the certification pattern (245). In FIG. 3, a diagonal line which is progressed from an upper left side to a lower right side is assumed as a pattern. The characters 1, 31, ?, and & which match the pattern order are sequentially input through the image keyboard or a keyboard and input once more to verify the input characters (250). The pattern depending on the input character order is transmitted to the server 10 and stored in the sever 10 (255).

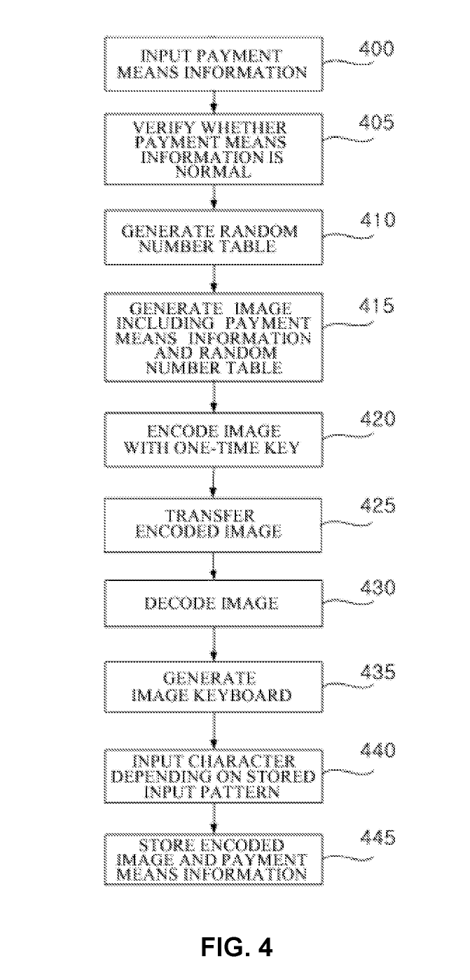

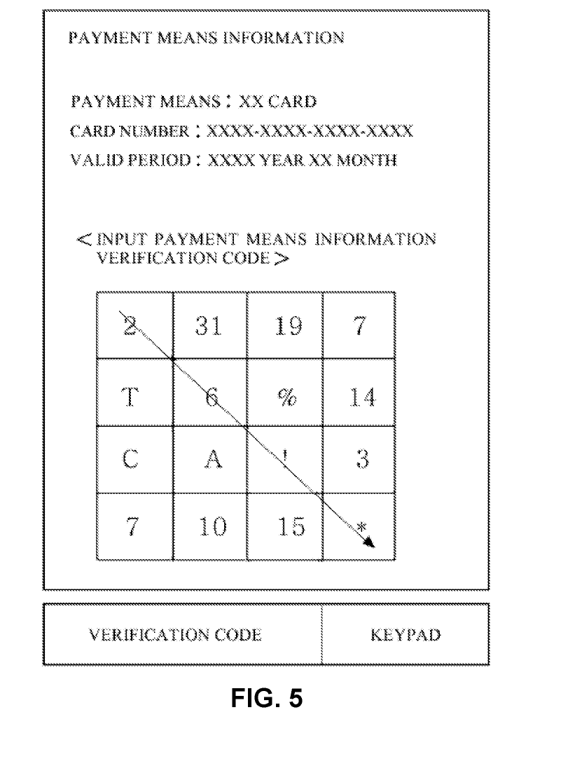

A storage method of payment means information is described with reference to FIGS. 4 and 5.

The user inputs the payment means information in the user terminal 20. In the case of a credit card, a card number, a valid period, a password, and the like, are input (400). The input payment means information is transferred to the server 10 and the server 10 communicates with a server (not illustrated) of a financial institution to verify whether the corresponding payment means is a normal payment means (405). The server 10 generates the random number table (410) and herein, the payment means information is preferably used as the challenge value.

The server 10 generates the image 11 including the payment means information and the random number table (415) and encodes the image 11 with the one-time key generated based on the first information and generates the encoded image 13 (420). The image 11 may be a single image including the payment means information and the random number table and an image divided into the image in which the payment means information is displayed and the image in which the random number table is displayed. The same applies to cases of payment history information and the random number table described below.

The encoded image 13 is transferred to the user terminal 20 and the user terminal 20 decodes the encoded image 13 with the one-time key generated based on the first information (430). When the encoded image 13 is decoded, the payment means information and the random number table are displayed in the user terminal 20 as illustrated in FIG. 5.

The user terminal 20 generates the image keyboard by using the payment means information as the challenge value (240). In this case, the used challenge value is the same as the challenge value used in step 410. As described with reference to FIG. 2, the image keyboard additionally includes other characters (including the figures) in addition to a value of the random number table to allow the user to input the characters of the random number table.

The user inputs the characters which follow the set certification pattern (440). As described above, in the present specification, since a diagonal direction which faces the lower right side from the upper left side assumes the certification pattern, the certification may be received only by inputting 2, 6, !, and * in the random number table illustrated in FIG. 5.

When the input characters coincide with the characters that follow the certification pattern, the payment means information is stored in the server 10 (445). Further, the encoded image is stored in the server 10 in order to prevent denial and store a certification result. A storage result may be notified to the user terminal 20.

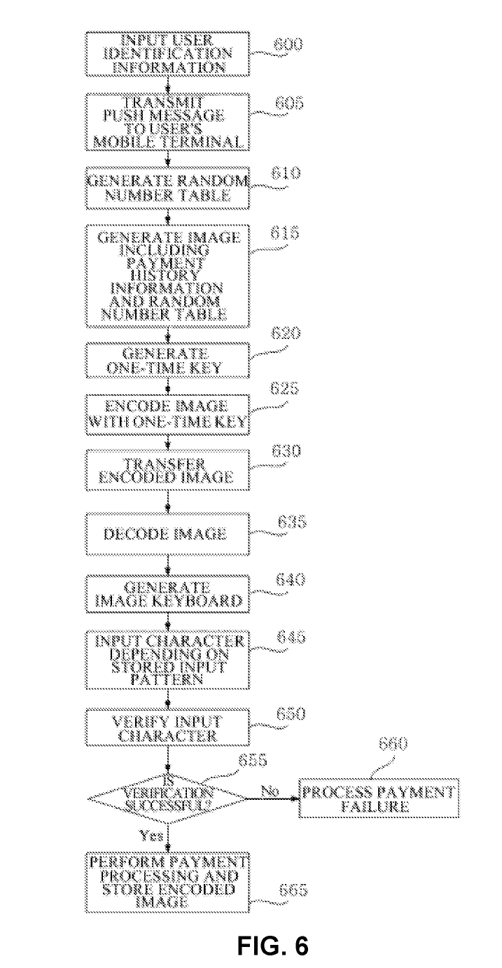

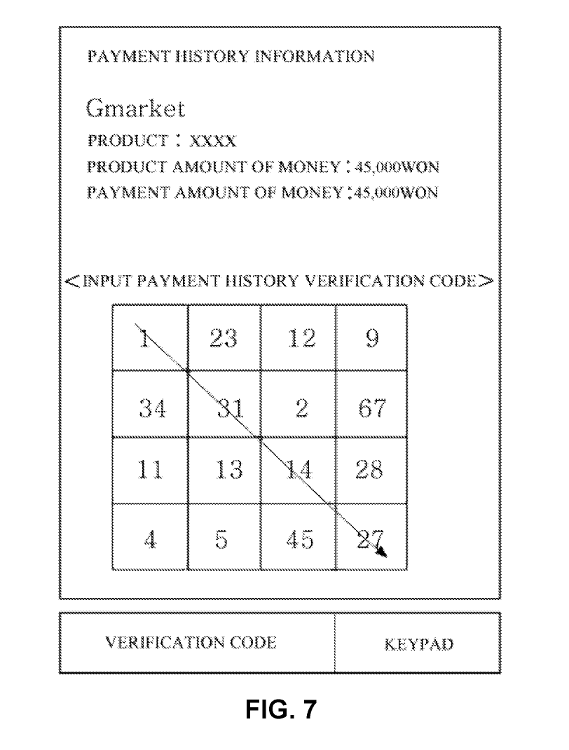

Next, a payment method according to the present invention will be described with reference to FIGS. 6 and 7.

When the user intends to purchase an article/service (hereinafter, referred to as “article”) by accessing an online shopping mall, and the like, the user selects a payment method to be used. When the user selects mobile payment according to the present invention, the user inputs user identification information to log in (600).

The server 10 transmits a push message to the user terminal 20 of the user (605). The server 10 generates the random number table by using the payment history information as the challenge value (610). In addition, the server 10 generates the image including the payment history information and the random number table (615). Further, the server 10 generates the one-time key based on the first information (620) and encodes the image 11 with the generated one-time key (625). The encoded image 13 is transferred to the user terminal 20 (630) and the user terminal also decodes the encoded image 13 with the one-time key generated based on the first information (635). One example of the decoded image is illustrated in FIG. 7.

The user terminal generates the image keyboard by using the payment history information as the challenge value and other characters (including the figures) are additionally included in the value of the random number table generated in step 610 to allow the user to input the characters of the random number table.

The user verifies the payment history information in the decoded image displayed in the user terminal 20 and inputs the characters depending on the certification pattern in the random number table when the payment history information is correct (645). According to the certification pattern in the present specification, 1, 31, 14, and 27 are sequentially input in FIG. 7.

The input characters are transmitted to the server 10 to verify whether the input characters are values depending on the certification pattern (655) and when the verification is unsuccessful, payment failure processing is performed (660) and when the verification is successful, payment processing is performed and the encoded image is stored in order to prevent the denial and store the certification result. A payment processing result may be notified to the user terminal 20.

Hereinabove, the present invention has been described with reference to the accompanying drawings, but it should not be interpreted that the scope of the present invention is determined by claims described below and limited to the aforementioned embodiment and/or drawings. In addition, it should be apparently appreciated by those skilled in the art that improvement, changes, and modification of the invention disclosed in the claims are also be included in the scope of the present invention.
10: Server
11: Image
13: Encoded image
20: User terminal

1. A method for determining and storing a certification pattern by a user terminal in an environment including a server and the user terminal capable of data communication with the server, the method comprising:
a first step of encoding, by the server, an image including a random number table with a one-time key generated on the basis of first information and transmitting the encoded image and receiving, by the user terminal, the transmitted encoded image;
a second step of generating, by the user terminal, the one-time key on the basis of the first information and decoding the encoded image;
a third step of receiving, by the user terminal, characters arranged according to a predetermined pattern in the random number table; and
a fourth step of sending, by the user terminal, the pattern determined by means of the inputted characters to the server, and storing the pattern in the server.

2. The method according to claim 1, the method further comprising:
a fifth step of receiving, by a user terminal, payment means information and transmitting the received payment means information to the server;
a sixth step of encoding, by the server, an image including a random number table and the payment means information with a one-time key generated on the basis of first information and transmitting the encoded image and receiving, by the user terminal, the transmitted encoded image when the payment means information is available;
a seventh step of decoding, by the user terminal, the encoded image with the one-time key on the basis of the first information;
an eighth step of receiving, by the user terminal, characters of the random number table and sending the received characters to the server; and
a ninth step of determining, by the server, whether the characters input in the eighth step coincide with the characters which follow a pattern stored in the fourth step and storing the payment means information when the characters coincide with each other and receiving, by the user terminal, a storage result.

3. The method of claim 2, the method further comprising:
a tenth step of encoding, by receiving, by a server receiving payment history information from an online shopping mall accessed by a user, an image including a random number table and payment history information with a one-time key generated on the basis of first information and transmitting the encoded image and receiving, by the user terminal, the transmitted encoded image;
an eleventh step of decoding, by the user terminal, the encoded image with the one-time key generated on the basis of the first information;
a twelfth step of receiving, by the user terminal, characters of the random number table and transmitting the received characters to the server; and
a thirteen step of determining, by the server, whether the characters input in the twelfth step coincide with the characters which follow a pattern stored in the fourth step and approving payment and receiving, by the user terminal, an approval result.

4. The method of claim 1, further comprising:
a 3-1-st step of producing, by the user terminal, an image keyboard capable of inputting the characters displayed in the random number table.

5. The method of claim 2, further comprising:
an 8-1-st step of producing, by the user terminal, an image keyboard capable of inputting the characters displayed in the random number table.

6. The method of claim 3, further comprising:
a 12-1-st step of producing, by the user terminal, an image keyboard capable of inputting the characters displayed in the random number table.
